(19) United States
(12) Patent Application Publication
(10) Pub. No.: US 2007/0044660 A1
(43) Pub. Date: Mar. 1, 2007

(54) Air filter dry cleaning system and method

(76) Inventor: Michael J. McClelland, Vancouver, WA (US)

Correspondence Address: MARGER JOHNSON & MCCOLLOM, P.C., 210 SW MORRISON STREET, SUITE 400, PORTLAND, OR, 97204, US

(21) Appl. No.: 11/216,422

(22) Filed: Aug. 30, 2005

(51) Int. Cl. B01D 46/00

(52) U.S. Cl. 95/279

(57) ABSTRACT

An air filter dry cleaning system and method of dry cleaning an air filter is disclosed. The system includes a portable, mostly enclosed cabinet into which an air filter can be placed on two rollers. A blower hose attached to a blower motor blows diffused air onto the filter to dislodge particulate matter. A vacuum hose connected to a vacuum blower motor provides a diffused vacuum air flow to vacuum particulate matter from the air filter. A vacuum air flow connected to the same vacuum blower motor provides a vacuum air flow in the cabinet below the filter. The air vacuum air flow can be connected to a separate detachable dust collection system. Both the portable cabinet and dust collection system can be mounted on wheeled support structures.

### TECHNICAL FIELD

This disclosure relates to the field of air filter cleaning and more particularly to a dry method of air filter cleaning.

### BACKGROUND

Currently the vast majority of automotive and truck air filters are simply replaced after a given period of usage with the used filter simply being tossed into the waste stream. A wet-washing system was developed and is used for some air filters, such as those used in heavy-duty construction equipment. This wet washing system involves immersing the paper air filters into chemical and detergent solutions. The filters are then placed in ovens for hours of drying. After one wet-washing cycle, up to 30% of the resins holding the paper together could be leached out, allowing these fibers to float freely. This results in many failures in the paper air filters which, in turn, results in extensive damage to many engines using these faulty filters.

An example of a dry cleaning system for air filters can be found in U.S. Pat. No. 5,143,529 to Means, Jr. (“the Means patent”). The Means patent discloses placing large heavy-duty filters vertically on a rotating support structure. The rotating support structure vibrates the large filter and rotates the filter while a mechanical air nozzle is directed to blow air against the filter to dislodge particulate matter clogging the filter. An embodiment of this patent can be found in the Air Filter Cleaning Machine manufactured and used by Sonic Dry Clean™, Inc. The patented filter cleaning machine and the currently-used system, however, can only accommodate large filters used in heavy-duty equipment. In the currently-used system, smaller filters are cleaned in an auxiliary booth that is integrated to be part of the expensive and complicated large filter cleaner. Further, the system requires the use of a large air compressor and correspondingly large air storage tank.

Air filters that have been cleaned must be inspected for holes before they can be properly used again. A current system uses a halogen light bulb of at least 500 Watts that is inserted into a central portion of the air filter. This high intensity light source projects light out through any holes in the filter. This high-intensity light bulb, however, also creates intense amounts of heat requiring special handling equipment to ensure the safety of the operator and, if the light is left inserted in the air filter too long, the filter literally burns up.

What is needed is a simpler, inexpensive and more portable option for cleaning automotive, truck and other engine air filters. Further, what is needed is a cheaper and safer way to inspect a cleaned filter for holes.

### SUMMARY OF THE DISCLOSURE

One aspect of the disclosure is an automotive air filter cleaning apparatus that includes a mostly enclosed free-standing cabinet with at least two rollers positioned in the cabinet to receive an air filter to be cleaned. The apparatus further includes a blower hose and a vacuum hose and can include a vacuum airflow intake positioned below the at least two rollers.

Another aspect is a method of cleaning a cylindrical air filter that includes placing the cylindrical air filter on two parallel rollers mounted in a portable cabinet with a longitudinal axis of the air filter parallel to an axis of rotation of the rollers. The method includes blowing particulate matter from the air filter with a source of diffused forced air and vacuuming particulate matter from the air filter with a source of diffused vacuum flow. The particulate matter blown and vacuumed from the air filter is collected in a dust collection system.

The foregoing and other features and advantages will become more readily apparent from the following detailed description of a preferred embodiment of the invention, which proceeds with reference to the accompanying drawings.

### BRIEF DESCRIPTION OF THE DRAWINGS

FIG. 1 is a perspective view of an air filter dry cleaning system according to an embodiment of the invention.

FIG. 2 is a front elevation view of the cleaning cabinet of the air filter dry cleaning system of FIG. 1.

FIG. 3 is a rear elevation view of the cleaning cabinet of the air filter dry cleaning system of FIG. 1.

FIG. 4 is a cross-sectional view of the cleaning cabinet of FIG. 2 taken along lines 4-4 in FIG. 2.

FIG. 5 is a perspective view of an air filter inspection wand according to another embodiment of the invention.

FIG. 6 is a perspective view of the air filter inspection wand of FIG. 5 shown inserted into an air filter.

### DETAILED DESCRIPTION

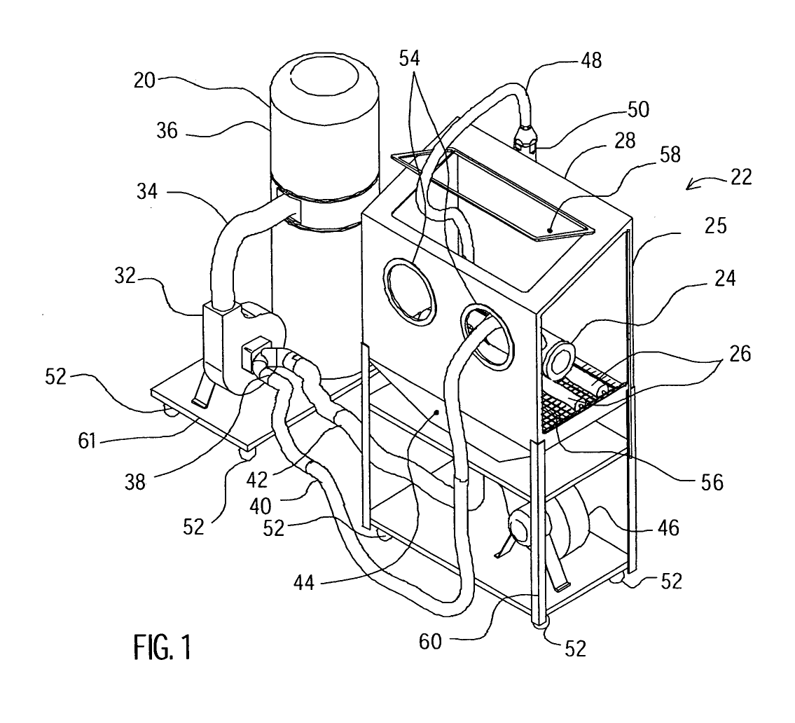

FIG. 1 is a perspective view of an air filter dry cleaning system 22 according to an embodiment. Automotive air filter 24 is placed within a cabinet 28. Side door 25 can be closed to mostly enclose the air filter 24 within the cabinet 28, thereby preventing particulate matter from spreading around the work area during the cleaning process.

In the embodiment shown in FIG. 1, the filter is placed on two rollers 26 positioned within the cabinet 28. More rollers 26 could be positioned in the cabinet 28 to accommodate more air filters 24.

A blower hose 48 and vacuum hose 40 are subsequently inserted into the mostly enclosed cabinet 28. The blower hose 48 and vacuum hose 40 can be inserted into the cabinet 28 through either the access holes 54 on the front face of the cabinet 28 or through an openably adjustable upper window 58.

The cabinet 28 can be mounted on a support structure 60 that has wheels 52 making the cabinet 28 easily movable. A blower motor 46 connected to the blower hose 48 through pipe 50 can also be mounted on the same wheeled support structure 60 thereby coupling the portability of the cabinet 28 with the blower motor 46 and blower hose 48.

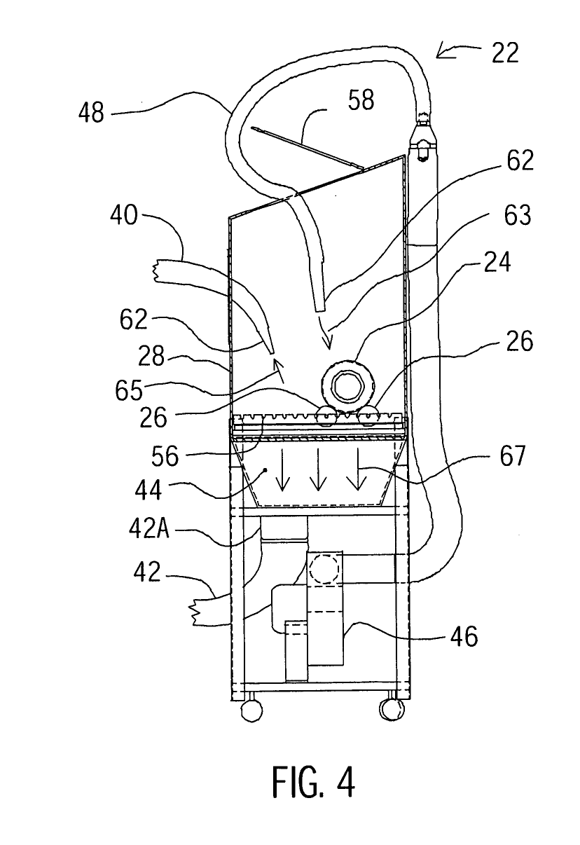

The intake end of hose 42 can draw a vacuum air flow 67, shown in FIG. 4, from the cabinet 28 by positioning the intake end 42A of hose 42 proximate to an area of the cabinet 28. This area can be a hopper region 44 positioned below the rollers 26 to collect particulate matter dislodged from the air filter 24 during the cleaning process. The vacuum air flow 67 below the rollers helps to keep the particulate matter from spreading to the surrounding area. Grate 56 positioned below rollers 26 can prevent any larger items like tools from dropping down into the hopper region 44 of the cabinet 28.

Vacuum motor 32 can be similar to or the same type of blower motor as the blower motor 46. As shown in FIG. 1, the vacuum motor 32 can be adapted to provide the vacuum air flow under the rollers 26 with hose 42 and provide vacuum air flow to the vacuum hose 40 by connecting the two hoses 40, 42 to the intake of the vacuum motor 32 through y-connector 38.

Vacuum blower motor 32 can have a discharge connected to a dust collection bag 36 through hose 34. The dust collection system 20 can be a standard off-the-shelf shop dust collector. One example of an off-the-shelf system is a JET® DC-1100 Dust Collector manufactured by WHM TOOL GROUP™ which includes the dust collection bag 36 and vacuum blower motor 32 on a common support structure 61 with wheels 52 for added mobility. Other manufacturers sell similar dust collection systems that would work well with the embodiment of the invention shown in FIG. 1.

Hose 42 easily detaches from the hopper region 44 of the cabinet 28, thereby making the whole vacuum blower motor 32, vacuum hose 40, hose 42 and dust collection bag 36 detachable from the cabinet 28.

The air filter 24 shown in FIG. 1 is a cylindrical air filter that is placed on the rollers 26. The cylindrical air filter 24 can then rotate on the rollers 26 to expose the entire filter to the blower hose 48 and the vacuum hose 40 during the cleaning process. The filter 24 rotates on the rollers 26 from the force of the air from blower hose 48 or the operator can manually rotate the filter 24 on rollers 26. The rollers 26 can be mechanically driven to rotate the filter 24, however, mechanical driving is not necessary.

While a cylindrical air filter 24 is shown in FIG. 1 in combination with rollers 26, any air filter sized to fit in the cabinet 28 can be placed in the cabinet 28 on grate 56 and cleaned using the blower hose 48 and the vacuum hose 40 with the vacuum air flow 67, shown in FIG. 4, supplied to the hopper region 44 by vacuum hose 42.

Filters that can be cleaned include, but are not limited to, flat ring-shaped filters and square-shaped filters (not shown). With these types of filters, the system operator would move the filter by hand to expose the entire filter to the blower hose 48 and vacuum hose 40 rather than spinning the filter on rollers 26. Further, other types of air filters beyond engine air filters can also be cleaned using the air filter dry cleaning system 22. Such filters include those used to filter air in the cabs of heavy-duty construction and excavation equipment.

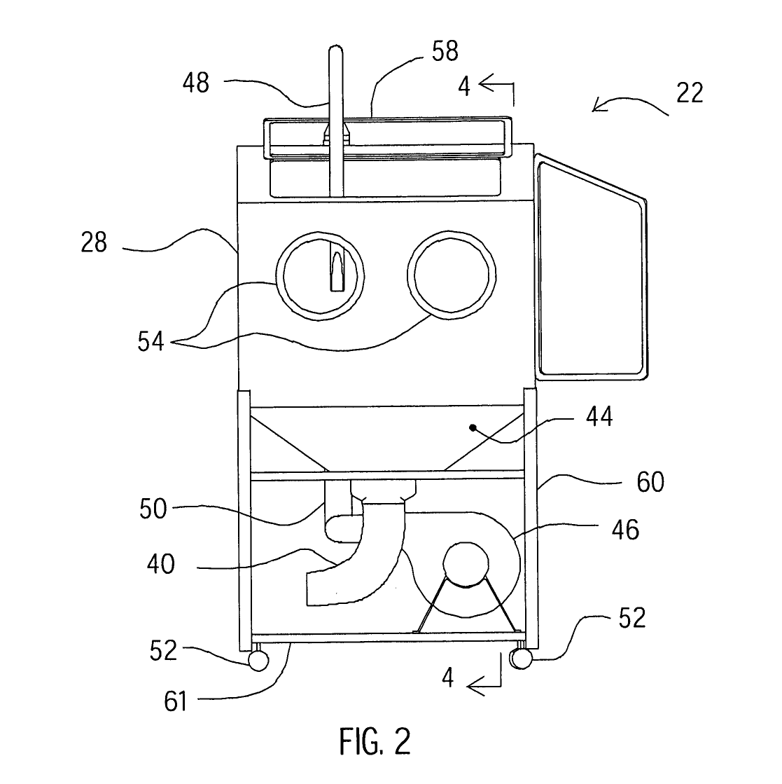

FIG. 2 is a front elevation view of the air filter cleaning system 22. Side door 25 is shown in an open position for placing the filter 24 of FIG. 1 in the cabinet 28 for cleaning. By closing the side door 25 during the cleaning process, particulate matter blown or falling from the air filter 24 is retained within the cabinet rather than being spread around the general work area.

Blower hose 48 is shown inserted into the cabinet 28 through the partially opened upper window 58. The amount of vacuum force applied to the inside of the cabinet 28 by hose 42 connected to the lower hopper region 44 can be varied by varying the amount the upper window 58 is opened or closed. A system operator can reach the blower hose 48 through the access holes 54 on the front face of the cabinet to manipulate the hose 48 during the cleaning process.

The cabinet 28 is shown mounted on support structure 60 which includes wheels 52. The blower motor 46 is also shown mounted on the support structure 60. The support structure 60 can be combined with the support structure 61 that supports an off-the-shelf dust collector as described above with respect to FIG. 1. The blower motor 46 can be the motor supplied with the dust collector system 20 reconfigured for connecting to the blower hose 48. The wheels 52 on support structure 61 provide mobility to the overall support structure 60, cabinet 28, blower motor 46 and blower hose 48.

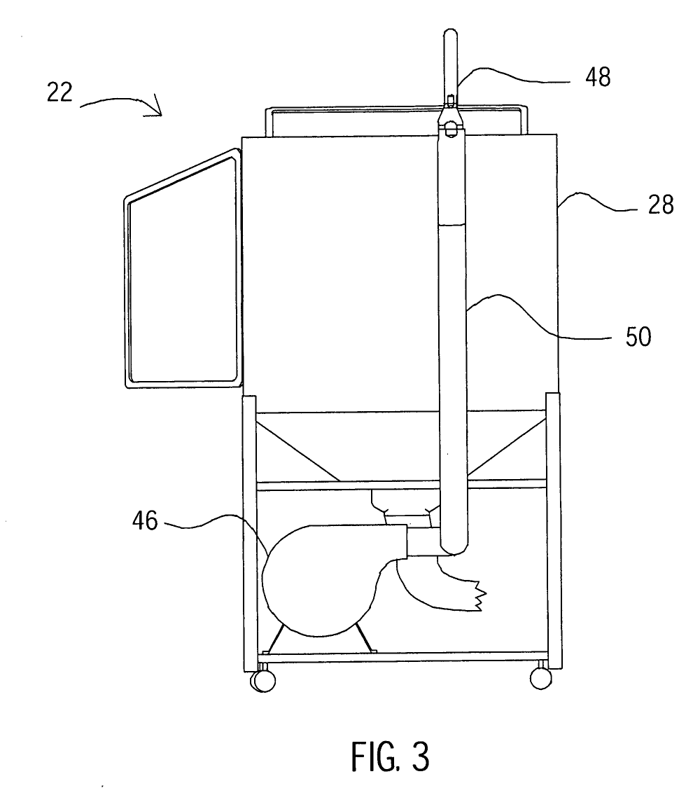

FIG. 3 is a back elevation view of the air filter cleaning system 22. The blower hose 48 can be connected to blower motor 46 through stack 50. The stack 50 can be made of a material stiffer than hose 48 and mounted along the back side of the cabinet 28. The stack 50 allows the blower hose 48 to be shortened and therefore easier to maneuver during the cleaning operation and moving of the cabinet 28.

FIG. 4 is a cross-sectional view of the air filter cleaning system 22 of FIG. 1 taken along line 4-4 in FIG. 2. Blower hose 48 shown having a wand attachment 62 from which diffused air flow 63 can be blown onto the filter 24 to dislodge unwanted particulate matter. By making the blowing air 63 diffused, the air filter 24 is not damaged during the cleaning process. Vacuum hose 40 is shown having a wand attachment 62 from which a diffused vacuum flow 65 can vacuum unwanted particulate matter from the air filter 24. As with the blower hose 48, by making the vacuum flow 65 diffused, the vacuum flow will not damage the air filter 24 during the cleaning process.

A method of cleaning a cylindrical air filter 24 using a dry cleaning process will now be described with reference to FIGS. 1 and 4. A cylindrical air filter 24 is placed on two parallel rollers 26 that are mounted in a portable cabinet 28 on grate 56. The longitudinal axis of the air filter 24 is parallel to the axis of rotation of the rollers 26 so that the filter 24 can roll freely on the rollers 26 while the rollers support the filter 24 in the portable cabinet 28.

Diffused forced air 63 is blown from the blower hose 48 to dislodge and blow unwanted particulate matter from the air filter. The blower hose 48 can be connected to a blower motor 46 mounted on the same support structure 60 that supports the portable cabinet 28.

A diffused vacuum flow 65 is applied to the filter 24 from the vacuum hose 40 to draw unwanted particulate matter from the air filter 24.

The unwanted particulate matter is then collected by vacuum hose 42 connected to the hopper region 44 and by vacuum hose 40 which both send the particulate matter to dust collection system 20. The dust collection system 20 can be made movable by mounting the vacuum blower motor 32 and dust collector bag 36 on a platform 61 that includes wheels 52.

The particulate matter can be collected in the dust collection system 20 by applying a vacuum air flow 67 from hose 42 to the hopper region 44 of the cabinet 28 below the filter 24 and rollers 26. The force of the vacuum flow 67 can be controlled by varying the position of the hinged upper window 58 which thereby controls the amount of available air for the vacuum flow 67.

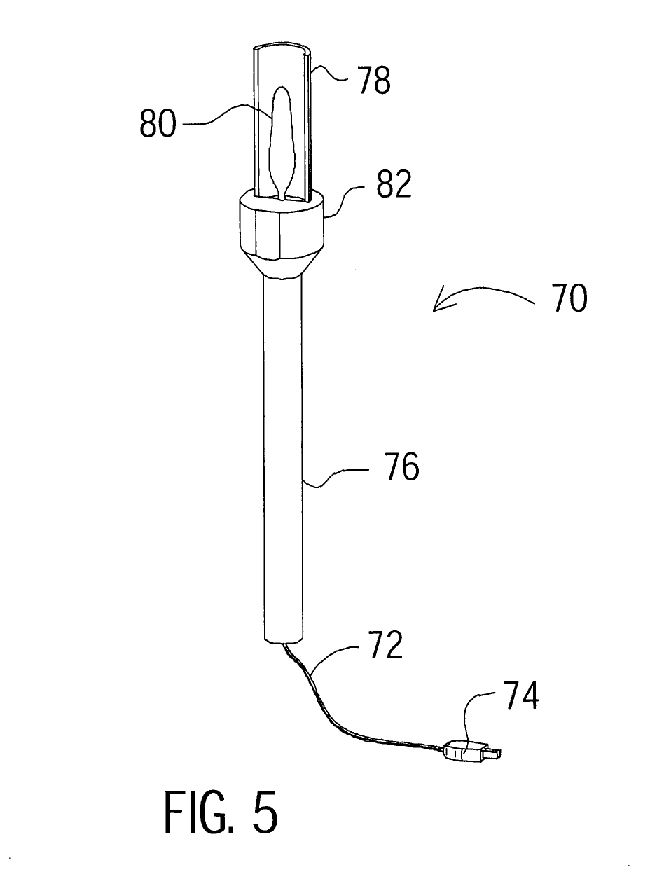

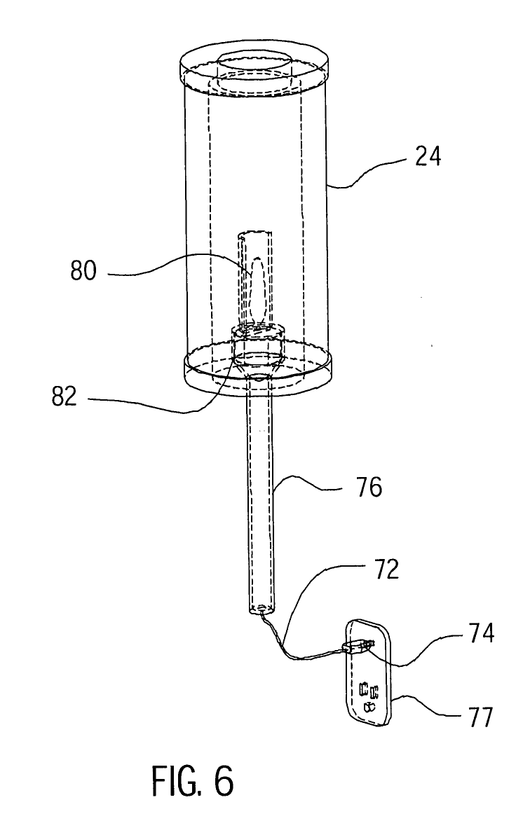

After the particulate matter is blown and vacuumed from the air filter 24, the air filter 24 can be inspected for holes using light wand 70 shown in FIGS. 5 and 6. The filter 24 can be placed in a darkened space, which includes but is not limited to a darkened room, a darkened booth, or the cabinet 28. The light wand 70 is then inserted into the central portion of the air filter 24. Light source 80 on support 82 is then illuminated. Any holes in the air filter 24 will be seen as a bright light emanating from the light source 80 through the hole. The light source 80 can be a less than 100 Watt light source and can be a 60 Watt halogen light bulb which can be powered by inserting plug 74 into a household electrical outlet 77.

FIG. 5 is a perspective view of a light wand 70 for use as an air filter inspection system. The wand 70 includes a handle 76 on top of which support 82 supports light bulb 80 and shroud 78. The bulb and shroud are arranged to emit light in a radial direction when the bulb 80 and shroud 78 are inserted into the filter 24. The shroud 78 can help protect the bulb 80 and help reflect the light from the bulb 80 in the radial direction. The light is then concentrated toward the air filter 24.

FIG. 6 is a perspective view of the light wand 70 being inserted into a central portion of the air filter 24 to inspect the filter 24 for holes. To perform the inspection, the filter 24 and light wand 70 are placed in a darkened space and the light bulb 80 is illuminated when the light wand 70 is inserted in the filter 24. Holes can then be detected by detecting light escaping from the air filter 24.

What is claimed is:

1. An automotive air filter cleaning apparatus comprising:
a mostly enclosed free-standing cabinet;
at least two rollers positioned in the cabinet;
a blower hose; and
a vacuum hose.

2. The apparatus of claim 1 in which a vacuum air flow intake is positioned in the cabinet below the at least two rollers.

3. The apparatus of claim 2 further comprising a vacuum motor connected to the vacuum air flow intake and connected to the vacuum hose.

4. The apparatus of claim 1 in which the cabinet includes a wheeled support structure.

5. The apparatus of claim 4 further comprising a blower motor connected to the blower hose, in which the blower motor is mounted on the cabinet support structure.

6. The apparatus of claim 1 in which the cabinet includes access holes on a vertical face and an openably adjustable upper window.

7. The apparatus of claim 6, in which the blower hose and vacuum hose are arranged to enter the cabinet through the access holes.

8. The apparatus of claim 6, in which the blower hose and vacuum hose are arranged to enter the cabinet through an open portion of the upper window.

9. The apparatus of claim 1, in which the cabinet includes a grate positioned below the rollers.

10. An air filter cleaning system, comprising:
an air filter;
a portable cabinet;
a first air blower motor;
a second air blower motor;
a blower hose attached to a discharge of the first air blower motor to supply diffused forced air;
a first vacuum hose having a first end connected to an intake of the second air blower motor and a second end in fluid communication with a bottom portion of the portable cabinet; and
a second vacuum hose having a first end connected to the intake of the second air blower motor and a second end to provide a diffused vacuum force.

11. The system of claim 10 further comprising a dust collection system connected to a discharge of the second air blower motor.

12. The system of claim 11, in which the dust collection system is a detachable dust collection system.

13. A method of cleaning a cylindrical air filter, comprising:
placing the cylindrical air filter on two parallel rollers mounted in a portable cabinet, in which a longitudinal axis of the air filter is parallel to an axis of rotation of the rollers;
blowing particulate matter from the air filter with a source of diffused forced air;
vacuuming particulate matter from the air filter with a source of diffused vacuum flow; and
collecting particulate matter blown and vacuumed from the air filter in a dust collection system.

14. The method of claim 13, in which collecting particulate matter blown from the air filter in a dust collection system includes collecting particulate matter blown from the air filter by applying a vacuum air flow to a portion of the portable cabinet.

15. The method of claim 14, further comprising controlling a force of vacuum air flow to a portion of the portable cabinet by adjusting a position of a hinged door on an upper portion of the portable cabinet.

16. The method of claim 13, in which collecting particulate matter blown and vacuumed from the air filter in a dust collection system includes collecting particulate matter blown and vacuumed from the air filter in a movable dust collection system.

17. The method of claim 13, in which blowing particulate matter from the air filter with a source of diffused forced air includes blowing particulate matter from the air filter with diffused forced air emanating from a hose connected to a blower motor mounted on a structure supporting the portable cabinet.

18. The method of claim 13, further comprising inspecting the air filter for holes in a darkened space by inserting a less than 100 Watt light source into a central portion of the air filter.

19. The method of claim 19, in which the less than 100 Watt light source is a 60 Watt halogen light bulb.

20. A method of inspecting an air filter for holes comprising:
placing the air filter in a darkened space;
inserting a substantially radially directed light source having a wattage below 100 Watts into a center portion of the air filter; and
inspecting the air filter for holes by detecting light escaping from the air filter.

21. An air filter inspection system comprising:
a darkened space; and
a light wand having a less than 100 Watt lamp on a first end, in which the light wand is sized to fit inside a center portion of an air filter.

22. The system of claim 21, in which the light wand is structured to project the light from the less than 100 Watt lamp in a substantially radial direction.
